(19) United States
(12) Patent Application Publication
(10) Pub. No.: US 2007/0109639 A1
(43) Pub. Date: May 17, 2007

(54) Electromagnetic polarizing structure and polarized electromagnetic device

(76) Inventors: Wang Jih-Fu Trevor, Changhua City (TW); Chi Jim-Yong, Taichung City (TW)

Correspondence Address: J.C. Patents, Inc., Suite 250, 4 Venture, Irvine, CA, 92618, US

(21) Appl. No.: 11/439,478

(22) Filed: May 22, 2006

(30) Foreign Application Priority Data
Nov. 14, 2005 (TW) 94139860

(51) Int. Cl. G02B 5/30

(52) U.S. Cl. 359/494; 359/483

(57) ABSTRACT

An electromagnetic polarizing structure can polarize a non-polarized (or a partially polarized) electromagnetic (EM) wave completely. The EM polarizing structure includes a layered structure. Several medium nodes are located in such a polarizing layer and distributed as a two-dimensional unit cell array on a plane. The array unit cell has an operation axis, which passes the diagonal. These medium nodes are distributed asymmetrically with respect to the operation axis. A polarizing EM device with the foregoing EM polarizing structure and a radiation-active structure can thus emit a polarized EM wave.

### CROSS-REFERENCE TO RELATED APPLICATION

This application claims the priority benefit of Taiwan application Ser. No. 94139860, filed on Nov. 14, 2005. All disclosure of the Taiwan application is incorporated herein by reference.

### BACKGROUND OF THE INVENTION

1. Field of Invention

The present invention relates to an electromagnetic (EM) wave polarizing technique, more particularly, to an EM wave polarizing structure technique, which can polarize a non-polarized (or a partially polarized) EM wave (or light) completely.

2. Description of Related Art

Generally, most of electromagnetic (EM) waves in nature exist in a non-polarized state. Herein, light refers to EM waves having a frequency within a specific range. Since the electric field direction of the non-polarized EM wave is not unique in one direction, the non-polarized EM wave is not suitable for (or limited to) certain applications. For example, laser systems, display devices, or optical telecommunications systems and the like all require polarized light, and therefore, the polarizer to polarize EM waves will be indispensable for many applications. There are a variety of ways to design a polarizer, and a grating-type or polymer-type polarizer is most commonly in use. However, with the advent of semiconductor techniques, there are other new ways to design a polarizer.

Nowadays, semiconductor opto-electronic devices, such as light emitting diode (LEDs) and vertical cavity surface-emitting lasers (VCSELs), are widely used as light sources. The brief description below is made with respect to LEDs and VCSELs. FIG. 1 is a schematic cross sectional view of a conventional LED structure. In FIG. 1, the conventional LED includes a transparent substrate 100, a bottom clad layer 102, an active layer 104, and a top clad layer 106, which are formed sequentially on the transparent substrate 100. In addition, an electrode layer 108 is formed on the top clad layer 106, and another electrode layer 110 is formed below the substrate 100. FIG. 1 shows the basic structure of a semiconductor LED, and the detailed structure should be understandable by those ordinary skilled in the art, and will not be described any more.

FIG. 2 shows the light emitting mechanism of a LED. When an operation voltage is applied to the top and bottom electrode layers 108, 110, holes 114 and electrons 116 will be driven by the electric field to move toward the active layer 104. The potential distribution of the hole 114 is shown as a potential line 111, and that of the electron 116 is shown as a potential line 112. When the holes 114 and the electrons 116 recombine and annihilate in the active layer 104, the light 118 thus emits according to the energy thereof. This emitted light is generally non-polarized or partially polarized.

FIG. 1 is a simplified schematic view of a conventional LED or the surface-emitting laser, which is used as a light source, but without any polarizing effect. In practical applications, in order to obtain the polarized light, a polarizer is required to turn non-polarized light into polarized light. With the advent of semiconductor fabrication techniques and electromagnetic wave theory, it's possible that the structure to polarize the light can be incorporated and integrated within the LED directly. However, the structure to polarize the light can be achieved only after careful design, and many manufacturers now continue to develop more efficient, lower cost, and easily made EM polarizing structure.

Conventionally, the polarized EM wave is produced by polarizing a non-polarized (or a partially polarized) EM wave (or light) through a polarizer, or by the way of combining the polarizer and light emitting devices (LEDs). The disadvantages of these methods are stated as follows: 1. The conventional polarizer reduces the light intensity by more than a half while light propagates through it; 2. As for LED with a polarizer, the medium interfaces will cause multiple reflection loss; 3. The design and fabrication process of a conventional grating-type polarizer are excessively complex and expensive.

### SUMMARY OF THE INVENTION

In order to solve the above problems, the present invention utilizes a new design approach to directly integrate the EM polarizing structure into the existing devices without (or with few) additional materials, thereby significantly reducing the above disadvantages.

The present invention depicts an EM wave polarizing structure, wherein the passing EM wave interacts with an asymmetrical two-dimensional unit lattice cell array of medium nodes to separate or completely convert the TE mode component and the TM mode component of said EM wave into a single mode, which corresponds to a pre-selected frequency. As a result, it is achieved that a uniform, thorough (or nearly thorough) single directional TE eigen mode or TM eigen mode (polarized EM wave), and the corresponding direction of the electric field is uniform and in a single direction. An EM wave in the TE (or TM) mode is a propagating EM wave with the electric field (or magnetic field) parallel to the EM polarizing structure plane. The concept regarding TE (or TM) eigen mode direction, e.g., eigen mode such as TE_{0,1}, TE_{1,0}, and the like, can be referred to Shun Lien Chuang, Chapter 7, Physics of Optoelectronic Devices (John Wiley & Sons, Inc., 1995). A polarized EM device is also depicted herein, which includes the foresaid EM wave polarizing structure and a radiation structure layer, e.g., a LED, to emit the polarized EM wave (polarized light).

The present invention depicts an electromagnetic polarizing structure, which can polarize a non-polarized (or a partially polarized) EM wave. The EM polarizing structure includes a EM polarizing layer. The medium nodes are located in such a polarizing layer and distributed as a two-dimensional unit lattice cell array. This array has an operation axis, which passes the diagonal of a unit lattice cell. The foresaid medium nodes are distributed asymmetrically with respect to the operation axis. Herein, “symmetrical (or asymmetrical) with respect to the operation axis” is determined by rotating the plane with medium nodes by 180° along the operation axis. If the spatial distribution of medium nodes after rotation is the same as that before, the distribution is “symmetrical with respect to the operation axis;” and otherwise, it is “asymmetrical with respect to the operation axis.” As for the EM polarizing structure according to the preferred embodiment of the present invention, the medium nodes are distributed on a plane in a direction vertical to the polarizing layer.

According to the structure of the present invention, the polarized EM wave is generated via the interaction of the non-polarized EM wave and the foresaid asymmetrical two-dimensional unit lattice cell array, and the relationship there-between can be pre-determined through all eigen modes of TM mode component and TE mode component at point Γ of the photonic band structure (or band dispersion curve) of foresaid two-dimensional array according to different frequency and mode responses of foresaid non-polarized EM wave, The foresaid interaction will thus change the polarized direction of the corresponding electric field into a uniform and single directional one.

An EM polarizing device is designed to generate a polarized EM wave, which includes: a radiation (or active layer) structure associated with foresaid EM polarizing structure, capable of emitting a non-polarized or partially polarized EM wave, when operated, disposed between a layer of first conductivity type and a layer of second conductivity type; and an EM polarizing structure layer polarizing the foresaid passing non-polarized (or a partially polarized) EM waves from foresaid radiation structure. There are the medium nodes distributed on foresaid EM polarizing structure layer forming a two-dimensional unit cell array. The foresaid array has an operation axis, which passes the diagonal of a unit lattice cell, and foresaid medium nodes are distributed asymmetrically with respect to the operation axis; and electrodes associated with a layer of first conductivity type and a layer of second conductivity type, wherein the carriers from both layers annihilate in foresaid radiation structure and the foresaid device thus emits polarized light when an appropriated operation voltage is applied on the electrodes.

As for the EM polarizing device according to the preferred embodiment of the present invention, radiation structure layer and EM polarizing structure layer are integrated into a light-emitting device structure. In FIG. 3A, A first electrode layer 210 is formed below the substrate 200, wherein the first electrode 210 also can be used to reflect the incident EM wave (light). A first clad layer 202 is formed on the substrate 200, wherein the medium nodes are located at a depth of the first clad layer, and distributed as a two-dimensional asymmetric unit lattice cell array. An active layer 204 is formed on the first clad layer 202. A second clad layer 206 is formed on the active layer 204. A second electrode layer 208 is formed on the second clad layer 206. When a proper operation voltage is applied between the first electrode layer 210 and the second electrode layer 208, the active layer 204 will emit the non-polarized light, and the polarized EM wave (light) can be generated through the two-dimensional asymmetric unit lattice cell array. The second electrode layer 208 can be made up of transparent conducting materials or it can partially cover the second clad layer, as shown in FIG. 3A.

According to another preferred embodiment of the present invention, all the structures of the EM polarizing device in FIG. 3B are the same as those of the above embodiment except the position of foresaid two-dimensional asymmetric unit cell array and the foresaid medium nodes are not distributed in the first clad layer 202 but in the second clad layer 206.

According to an embodiment of the present invention, any medium node described above is a substance with a refractive index different from that of the clad layer or the polarizing layer, which is preferred to be, for example, a cavity.

According to an embodiment of the present invention, the foresaid first clad layer includes, for example, a first layer with multiple recesses on its surface and a second layer disposed on the first layer covering the recesses, and thus forming the medium node as shown FIG. 10B and 10D.

According to an embodiment of the present invention, the unit lattice cell of a two-dimensional asymmetric unit lattice cell array composed of the foresaid medium nodes preferably includes a rectangular unit lattice cell or an in-equilateral parallelogram unit lattice cell as shown in FIG. 5.

The foresaid EM polarizing structure is utilized in the present invention, efficiently polarizing the incident EM wave uniformly into an EM wave either in TE eigen mode or TM eigen mode with the electric field in a single direction Moreover, as the structure is simple, and it can be achieved by the semiconductor fabrication technique and costs are significantly reduced.

In order to the make the aforementioned and other objects, features, and advantages of the present invention comprehensible, a preferred embodiment accompanied with figures is described in detail below. It is understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic side view of a conventional light emitting diode (LED) structure.

FIG. 2 is a schematic view of the light emitting mechanism of the LED.

FIGS. 3A and 3B are schematic cross-sectional views of an exemplary LED according to an embodiment of the present invention.

FIG. 4A is a schematic top plane view showing the relationship between the medium nodes on the EM polarizing layer and the passing EM wave according to the embodiment of the present invention.

FIG. 4B is a schematic plane view of Γ-M, Γ-X on the two-dimensional reciprocal lattice vector space corresponding to a unit lattice cell of FIG. 4A.

FIG. 5 is a schematic plane view of a two-dimensional unit lattice cell array made up of medium nodes according to the present invention.

FIGS. 6A and 6B are photonic bands (band dispersions) of a two-dimensional asymmetric rectangular unit lattice cell array as a function of the projected incident wave number Ki_{∥}=2π/λ_{∥} with respect to point Γ according to the present invention.

FIGS. 7A and 7B show photonic bands (band dispersions) of a two-dimensional symmetric square unit cell array with the Γ point degenerate as a function of the projected incident wave number K_{∥}=2π/λ_{∥} with respect to point Γ.

FIGS. 8A and 8B are spatial distribution views of the intensity and direction of the electric field E and the magnetic field H of eigen mode A in FIG. 7B with respect to the XZ plane, corresponding to FIG. 7B, wherein the arrows indicate the direction of the electric field (or magnetic field); the intensity of the electric field is indicated with colors; the circles of solid line indicate the medium nodes 214; and the dashed arrows and the circles indicate the direction of the corresponding electric field E (or magnetic field H).

FIGS. 9A, 9B, 9C, and 9D are the spatial distributions of the intensity and direction of the electric fields of eigen modes A, B, C, and D in FIG. 6B with respect to the XZ plane, corresponding to FIG. 6B, wherein the EM waves of eigen mode A, B, C, and D are shown linearly polarized in these figures respectively.

FIGS. 10A, 10B, 10C and 10D are some examples of schematic cross-sectional views of fabricating the EM polarizing structure according to an embodiment of the present invention.

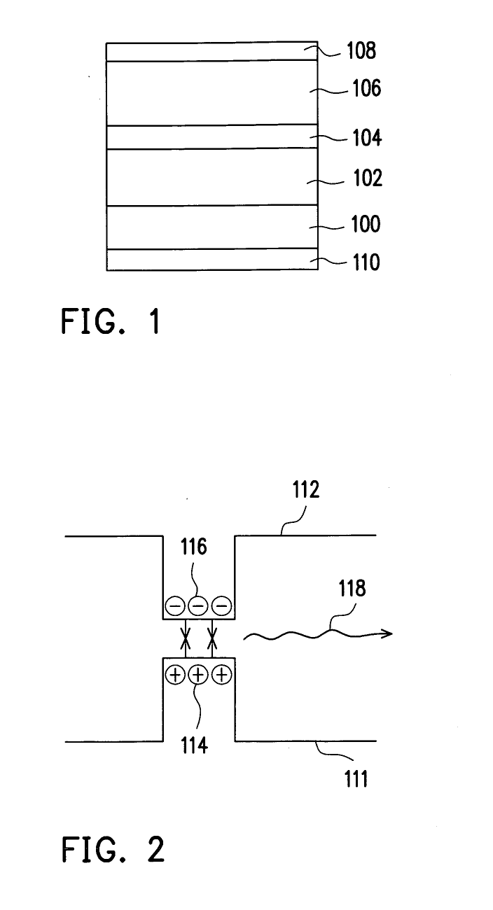

### DESCRIPTION OF EMBODIMENTS

According to electromagnetic wave theory, the non-polarized electromagnetic wave (EM wave) can decompose into two independent components: a TE mode and a TM mode, which correspond to two mutually perpendicular eigen modes with the electric field orthogonal to each other. If an EM wave only includes TE mode component or TM mode component, the EM wave is polarized. The EM wave mentioned herein includes visible light. A non-polarized EM wave can become polarized in TM-mode or in TE-mode if it interacts with the special device or material. The polarization mechanism for the non-polarized EM wave will be described below. Thereafter, a LED structure of the present invention will be taken as an example for description. However, the present invention is not limited to this example. It also works for a resonant cavity light emitting diode (RCLED) or a vertical cavity surface emitting laser (VCSEL).

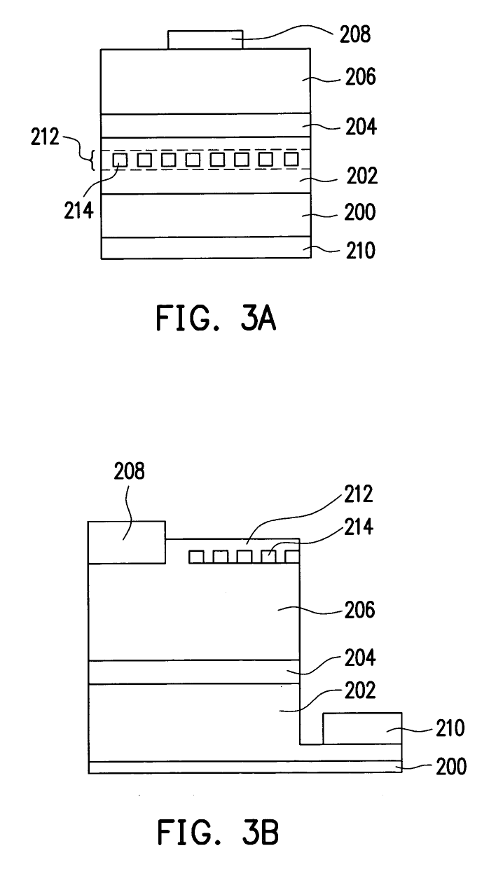

FIGS. 3A and 3B are schematic cross-sectional views of a LED according to an embodiment of the present invention. Referring to FIGS. 3A and 3B, the LED structure includes a substrate 200. The substrate 200 is made of a transparent material, such as, silicon, sapphire, or spinel. A clad layer 202, an active layer 204, and a clad layer 206 are formed on the substrate 200 in sequence, wherein the clad layer 202 of FIG. 3A (or clad layer 206 of FIG. 3B) includes a polarizing structure layer 212. The polarizing structure layer 212 has the medium nodes 214, which are arranged as a two-dimensional unit lattice cell array. If the light emitting device structure is a resonant cavity light emitting diode (RCLED or a vertical cavity surface emitting laser (VCSEL). A distributed Bragg reflectors is inserted or fabricated inside the clad layers 202 and 206 respectively enclosing the radiation structure 204 and the EM polarized structure 214.

The description of the distributed Bragg reflector can be referred to Carl Wilmsen, Henry Temkin and Larry A. Coldren, Chapter 3, Section 3.2.2 Reflectors “Vertical Cavity Surface Emitting Laser (Cambridge University Press, Cambridge, 1999)”.

From the point of optics, the two-dimensional periodic (or unit lattice cell) array composed of medium nodes 214 can be considered as a photonic crystal (or light crystal) of the EM wave. It's just like electrons move inside a periodic electric potential (crystal lattice). It can be understood herein that, a three-dimensional array structure can be constructed via two-dimensional unit lattice cell array layers, and the present invention is not limited to the two-dimensional array of a single layer. A two-dimensional symmetric unit lattice cell array according to the present invention has an operation axis, which passes the diagonal of a unit lattice cell. Generally, the TE mode component or the TM mode component of the non-polarized EM wave (light) is degenerate on the medium nodes 214 ( or at the point Γ). In short, the TM and TE modes at the Γ point have the same frequency response and cannot be separated from each other under this circumstance.

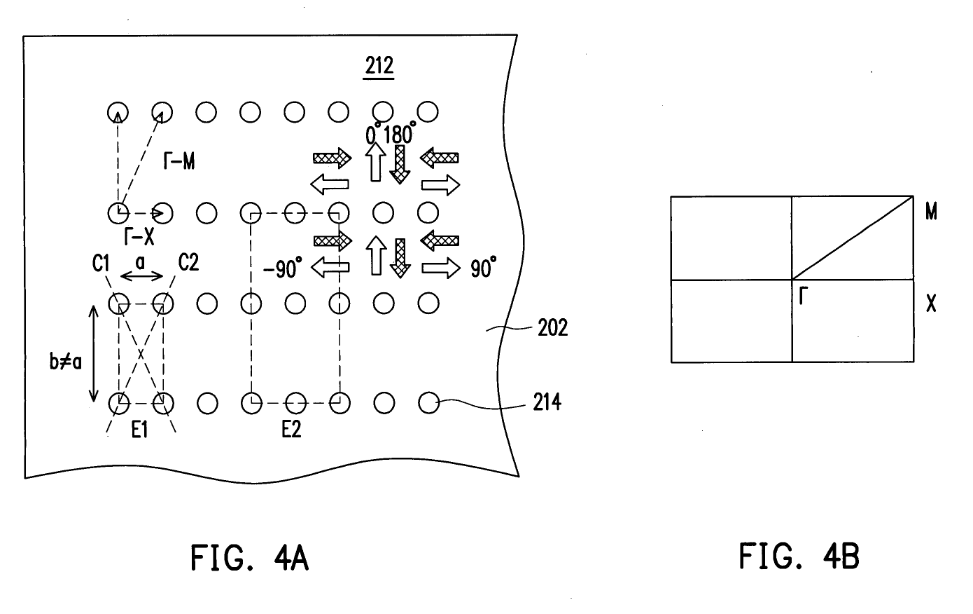

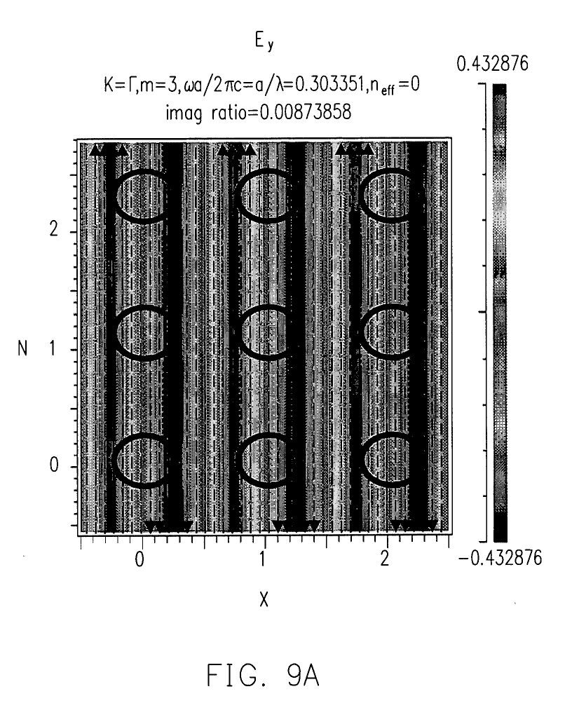

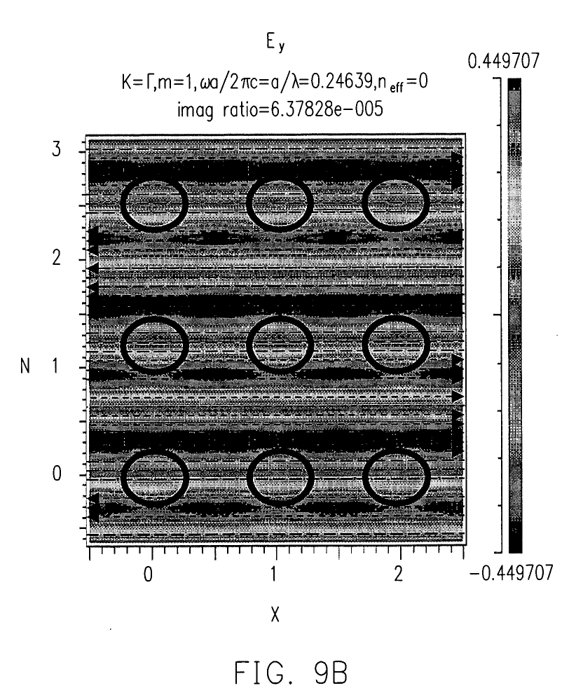

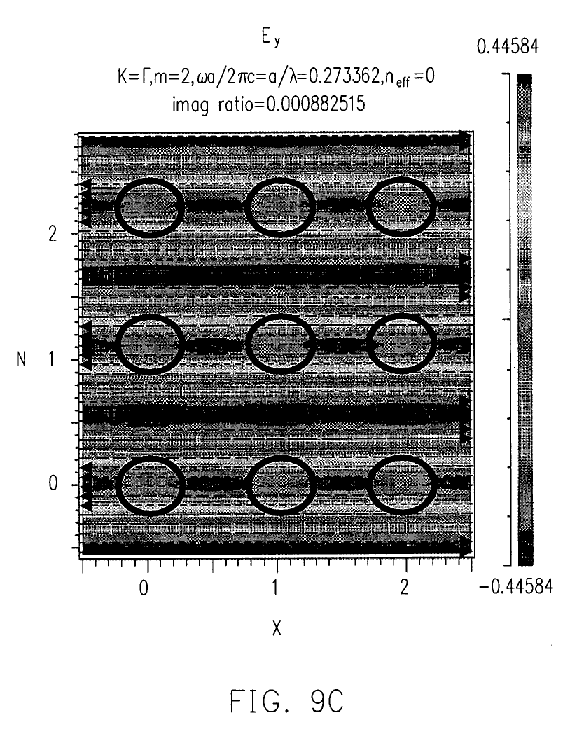

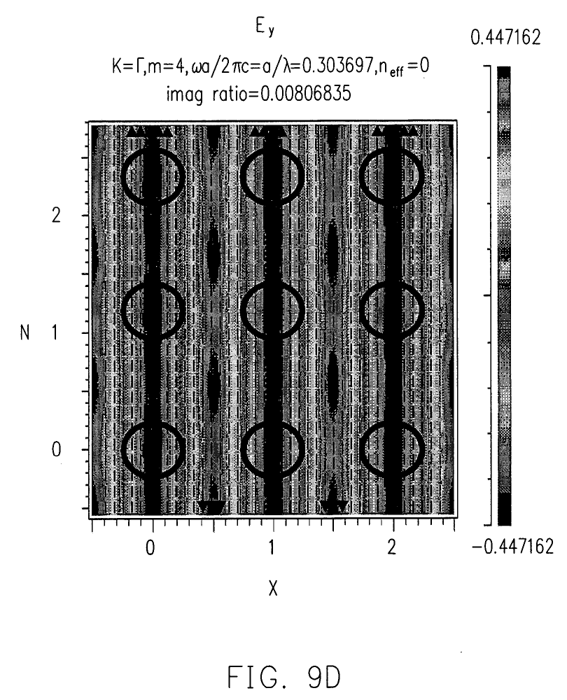

The medium nodes depicted in the present invention are distributed asymmetrically with respect to the operational axis. However, when the non-polarized incident EM wave interacts with foresaid two-dimensional asymmetrical unit lattice cell array, the TM and TE modes of foresaid EM wave on the medium nodes 214 are separated as a single or few similar eigen modes because of different frequency and mode responses of foresaid non-polarized EM wave. More detailed description will be made with reference to FIGS. 4A, 4B, FIGS. 9A, 9B, 9C, and 9D.

Then, two electrode layers 210, 208 are disposed on both sides of the structure. Also, FIG. 3A only depicts an example of the polarizing layer 212 with one layer. However, multiple layers can also be used depending upon the design requirements, and the medium nodes 214 can penetrate or not penetrate the polarizing layer 212, and another polarizing layer can also be disposed in the clad layer 206, for example. Also, since the electrode layer 210 can also reflect the EM wave (light) emitted from the active layer 204, the reflected EM wave (light) passes the polarizing layer 212 again, so as to enhance the polarization effect.

The polarizing mechanism and the medium nodes 214 on the polarizing layer 212 will be described below. FIG. 4A is a top plane view of the polarizing layer (XZ plane view) showing the relationship between the incident EM wave and the two-dimensional unit lattice cell array structure of medium nodes 214 on the polarizing layer 212. FIG. 4B is a schematic plane view of Γ-M, Γ-X on the reciprocal lattice vector plane corresponding to a unit lattice cell of FIG. 4A. If the medium nodes are distributed as a two-dimensional rectangular unit lattice cell array on a XZ plane, X directional unit is a, Z directional unit is b, and the corresponding reciprocal lattice unit vectors on the reciprocal lattice plane are thus Gₓ=2π/a and G_{z}=2π/b respectively as shown in FIG. 4B.

The projected electric field components of the incident EM wave parallel to X axis and Z axis are perpendicular to each other in FIG. 4A. For example, one of the electric fields oscillates back and forth between 0 degrees to 180 degrees, and the other electric field oscillates back and forth between −90 degrees and +90 degrees. If the projected foresaid EM incident wave number component (K_{∥}=2π/λ_{∥}) on the XZ plane is equal to the sum of any integral multiples of two reciprocal lattice unit vectors Gₓ=2π/a, G_{z}=2π/b, the EM wave will generate a Bragg diffraction wave on the XZ plane, that is, Equation (1) K_{∥}=mGₓ+nG_{z}, where m and n are integers. At this instant, the EM wave will be strongly modulated (similar to resonance) by the two-dimensional unit lattice cell array. As a result, the polarization state of the EM wave can be changed. The two-dimensional unit lattice cell array structure of the medium nodes 214 can be, e.g., the E l rectangular in FIG. 4A, with two sides a, b different with each other. This two-dimensional array structure is composed of, for example, rectangular unit lattice cells. The foresaid two-dimensional array has an operation axis, for example, one of the two diagonals C1, C2 of E1. The rectangular unit cell is asymmetric with respect to C1 or C2.

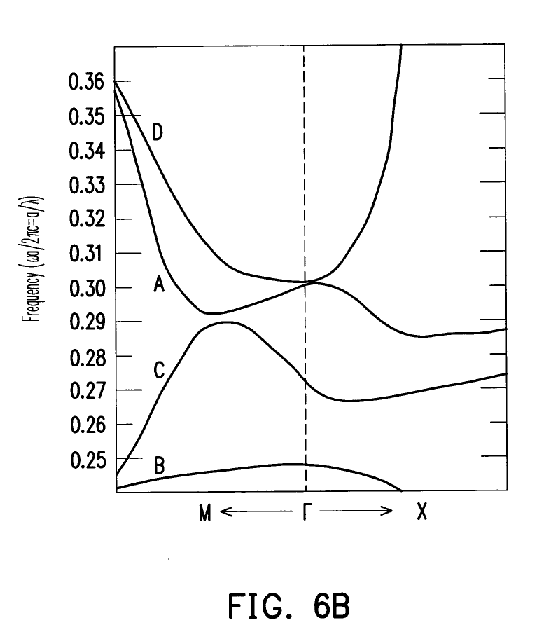

The position of the medium node 214 in FIG. 4B is referred as point Γ. The diagonal direction is defined as Γ-M and the direction from point Γ to the adjacent medium node 214 is defined as Γ-X. The asymmetrical structure of the present invention takes, for example, the diagonal C1 as the desired operation axis, and the medium nodes 214 around are asymmetrical with respect to the operation axis. As long as the medium nodes 214 are asymmetrical with respect to the operation axis, when the non-polarized EM wave is incident on the two-dimensional array in FIG. 4A, the TE and TM components originally degenerate on the medium nodes (point Γ.) will have different responses to the frequency change, that is, they will be separated or converted. Therefore, if the parameters of foresaid asymmetric unit lattice cell are properly selected and satisfy equation (1), a single or few nearly similar eigen modes of one of the TE and TM modes can be pre-selected. The mechanism of separating or converting the two components will be further described in FIGS. 6A-6B, FIGS. 7A-7B, FIGS. 8A-8B, and FIGS. 9A-9D.

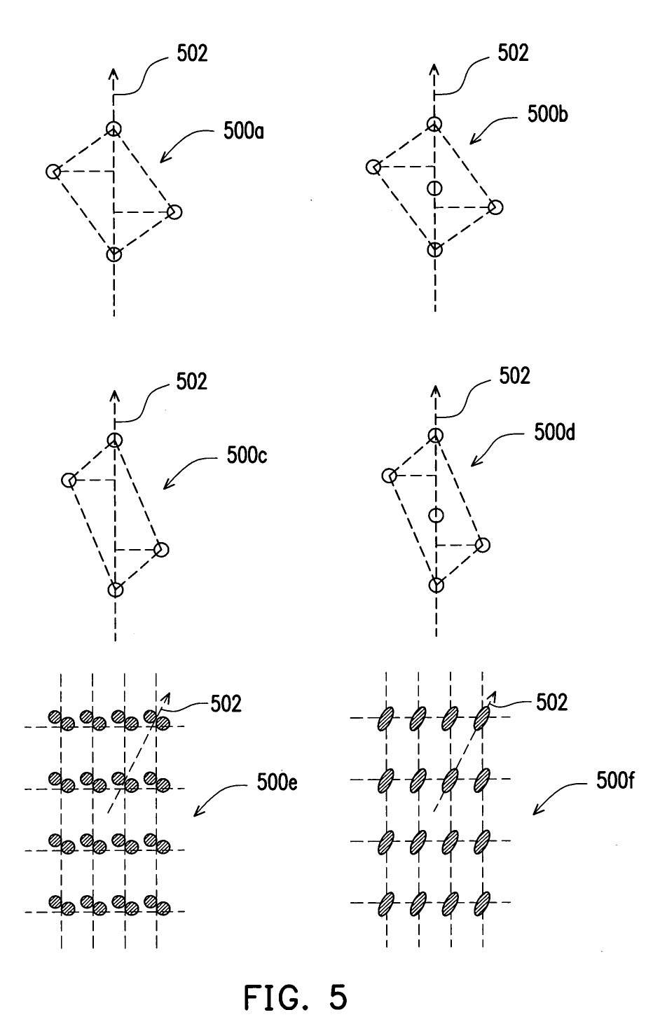

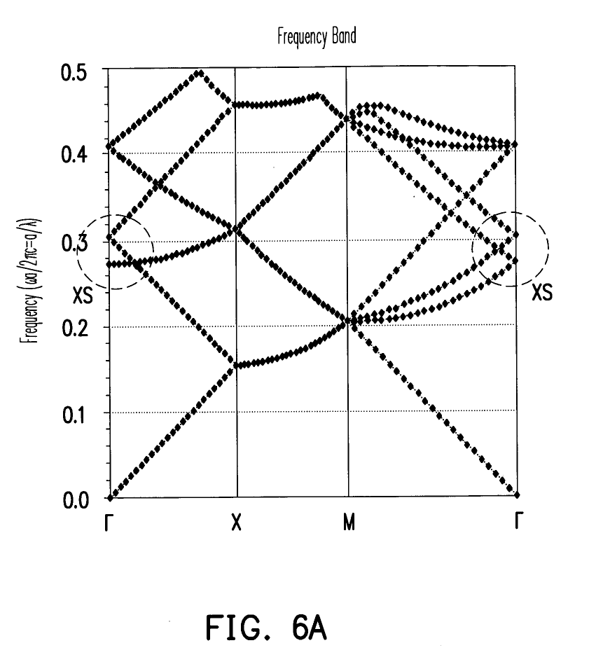

Furthermore, the asymmetrical spatial distribution of medium nodes with respect to the operation axis means that most medium nodes 214 are globally distributed asymmetrically, or all the medium nodes are distributed asymmetrically with respect to the operation axis. In other words, under a special circumstance, the medium nodes 214 can be locally distributed symmetrically in particular positions, but still being substantially asymmetrical with respect to the operation axis as a whole. The examples 500e and 500f are shown in FIG. 5. If the foresaid two-dimensional array is properly chosen, the incident non-polarized EM wave TE and TM can be further converted and separated into the polarized (purely TE or TM mode or modes) EM wave output. It will be further described with reference to FIGS. 9A, 9B, 9C, and 9D.

FIG. 5 is a schematic structural view of a unit lattice cell of a two-dimensional unit lattice cell array of medium nodes according to the present invention. In FIG. 5, as for the operation axis 502, 500a, 500b, 500c, 500d, 500e, and 500f are six specific embodiments of a unit cell structure. 500a is a rectangular unit lattice cell. It can be seen from the relationship shown by dash lines that the medium nodes 214 around are asymmetrical with respect to the operation axis 502. Also, 500b is a rectangular unit lattice cell with a center lattice point, and the medium nodes 214 around are asymmetrical with respect to the operation axis 502 either. Also, the unit lattice cell structure can be, for example, the in-equilateral parallelogram in 500c, and the medium nodes 214 around are asymmetrical with respect to the operation axis 502 as well. Similarly, the parallelogram 500d with a center lattice point also meets the requirements of the asymmetrical structure according to the present invention. 500e and 500f show, further for example, the structures for the medium nodes 214. However, FIG. 5 is only some preferred embodiments of the present invention. And as for the operation axis 502, as long as the medium nodes are distributed as a two-dimensional asymmetrical unit lattice cell array structure, the polarization effect disclosed in the present invention will be achieved as well.

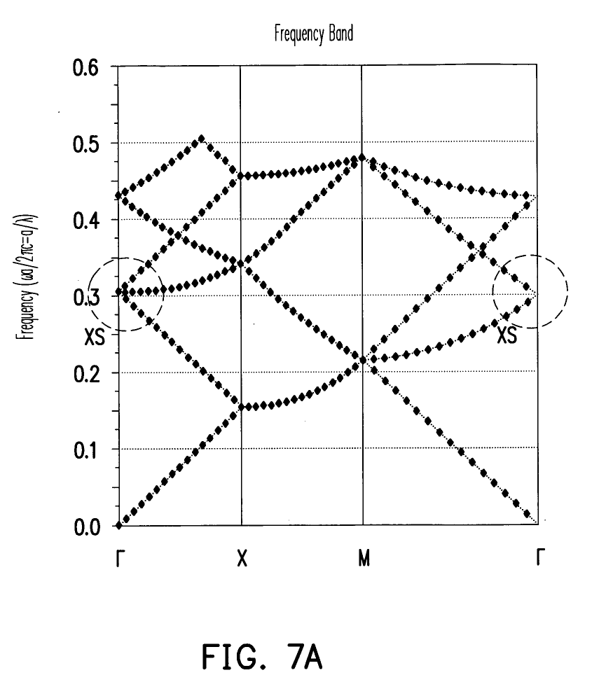

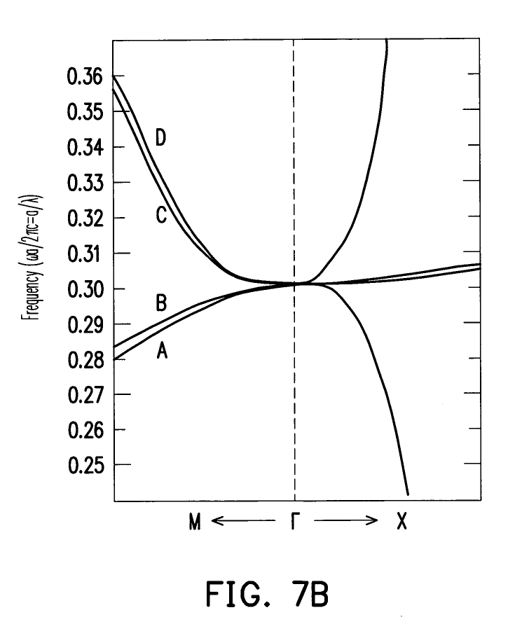

The phenomenon of generating the polarization effect will be described below. FIGS. 6A and 6B show the photonic bands (band dispersions) of a two-dimensional asymmetric rectangular unit lattice cell array as a function of the projected incident wave number (K_{∥}=2π/λ_{∥}) with respect to point Γ, wherein the K_{∥} vector is parallel to the two-dimensional asymmetric rectangular unit lattice cell array plane according to the present invention (λ=one EM wave wavelength). FIGS. 7A and 7B show the photonic bands (band dispersions) of a two-dimensional square unit lattice cell array as a function of the projected incident wave number (K_{∥}=2π/λ_{∥}) with respect to point Γ, wherein the K₈₁ vector is parallel to the two-dimensional symmetrical square unit lattice cell array plane. For example, the eigen mode A and B (resonant band) in the Γ-M direction are approximately degenerate at the point Γ in FIG. 7B, it means that mode A and B have the same frequency response, however, the foresaid structure of the present invention in FIGS. 6A and 6B can separate eigen mode A and B since the frequency and mode responses of eigen modes A and B are no longer the same at the point Γ. In the same way, the eigen modes C and D (resonant band) also can be separated. In FIGS. 6A-6B, the dielectric constants of the medium node and the background dielectric layer are, for example, 10.56 and 10.92 respectively. The ratio of the long axis (b) to the short axis (a) of the medium node period (or its unit cell) is b/a=1/0.85, r/a=0.252, c=light velocity, λ=one EM wave wavelength, ω=angular frequency of an EM wave, a=400 nm, r=radius of medium node hole. FIG. 6B is an enlarged view of the XS area of FIG. 6A, wherein the eigen modes A, B, C, and D are separated completely and are no longer degenerate.

As for the four resonant bands of eigen mode A, B, C, and D on the photonic band of a two-dimensional square unit lattice cell array structure as shown in FIG. 7B and FIG. 7B, FIG. 7A is the foresaid photonic band (or band dispersion) of a square unit lattice cell array in a wide range. FIG. 7B is an enlarged view of the XS area of FIG. 7A.

It can be seen from FIG. 7B in the Γ-M direction that the eigen modes A and B at point Γ are degenerate at one frequency, and the eigen modes C and D are degenerate at another frequency, wherein the dielectric constants of the medium nodes and their background dielectric layers are, for example, 10.56 and 10.92 respectively, and the ratio of the hole radius of the medium node (r) to the unit cell period (a) is r/a=0.252, a=400 nm.

In FIGS. 6A, 6B of the present invention, the eigen modes A and B are separated at different frequencies, and the eigen modes C and D are also separated at different frequencies. Therefore, when the parameters of asymmetric unit cell are properly selected, for example, only one of the eigen modes B and C will be selected, to achieve the polarization effect. The related basic conceptions and calculation principle of the photonic bands and the electric (or magnetic) field of the corresponding eigen modes in FIGS. 6A, 6B, FIG. 7A, 7B, FIGS. 8A, 8B, and FIGS. 9A, 9B, 9C, and 9D can be understood with reference to Joannopoulos et al., Photonic Crystals, Molding the Flow of Light, (Princeton University Press, Princeton, 1995), Meade et al. “Accurate Theoretical Analysis of Photonic Band-gap Materials”, Phys. Rev. B 48, 8434 (1993).

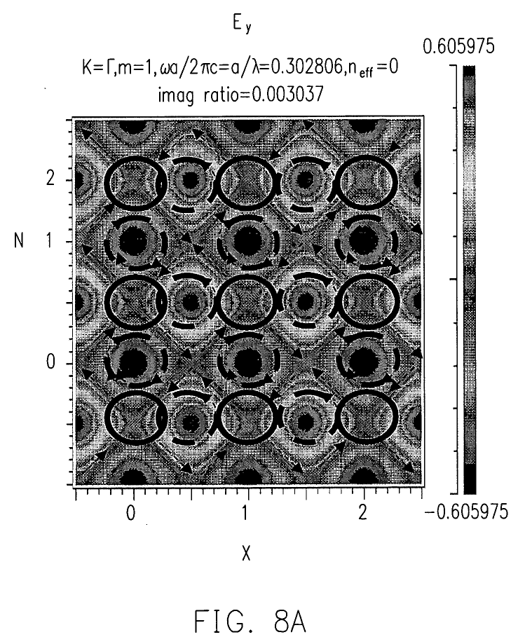

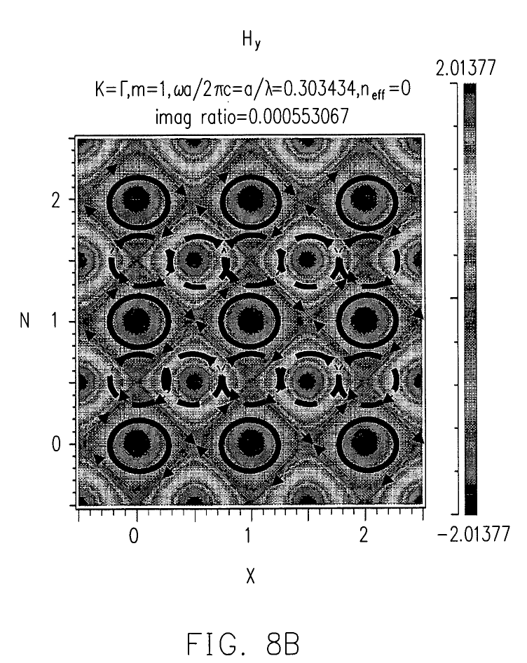

FIGS. 8A and 8B are spatial distribution view of the intensity and direction of the electric field E and the magnetic field H of eigen mode A on the XZ plane corresponding to FIG. 7B. The arrows indicate the direction of the electric field E (or magnetic field H); the intensity of the electric field E (or magnetic field H) are indicated by shading; the solid line circles indicate the medium nodes 214; and the dashed arrows and dashed circles indicate the direction of the corresponding electric field E (or magnetic field H).

FIGS. 9A, 9B, 9C, and 9D are spatial distribution views of intensity and direction of the electric fields of eigen modes A, B, C, and D on the XZ plane corresponding to FIG. 6B, wherein the EM waves of the eigen modes A, B, C, and D are linearly polarized as shown in the figures. Moreover, the corresponding frequency responses of the eigen modes A and D are close to each other, and the spatial distributions of the corresponding polarized electric fields are similar as well. Also, the spatial distributions of the corresponding polarized electric fields of the eigen modes B and C with different frequencies are also similar to each other. Therefore, a non-polarized (or a partially polarized) EM wave can be polarized, if the two-dimensional asymmetrical unit lattice cell array, r/a, and the unit cell period (or cycle) are properly selected. That is, the incident non-polarized wave with a particular frequency will resonate with the pre-selected two-dimensional asymmetric unit lattice cell array and the outgoing EM wave is thus polarized.

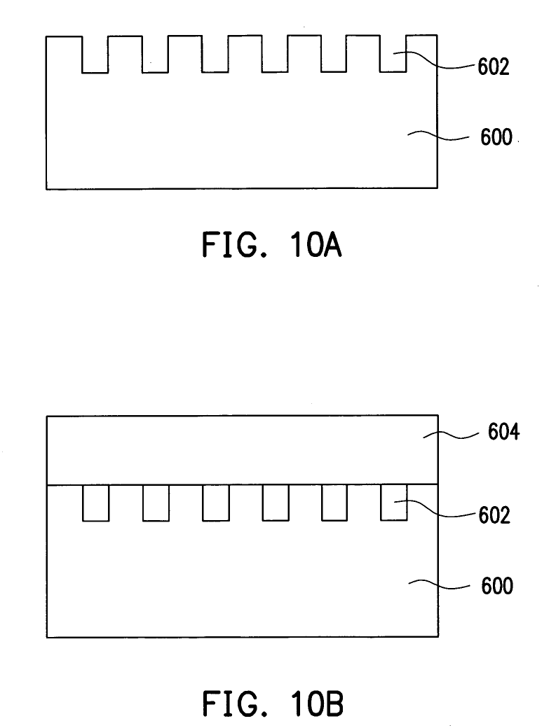

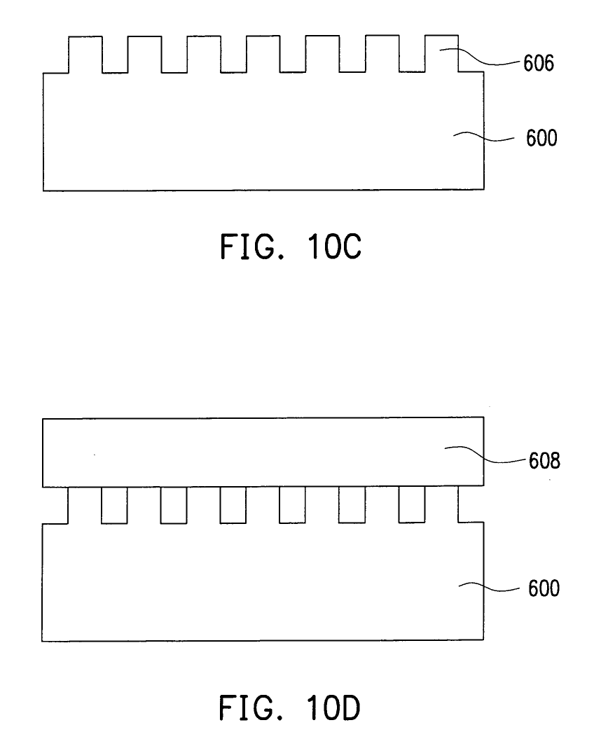

Then, an embodiment of how to fabricate the EM polarizing structure of the present invention will be described below. FIGS. 10A and 10B are cross-sectional views of the polarizer according to an embodiment of the present invention. In FIG. 10A, multiple recesses or through holes 602 are formed on a semiconductor material layer 600, wherein the recess is taken as an example herein. The positions of the recesses 602 are the positions of medium nodes 214 in FIGS. 3A, 3B. If only one EM polarizing structure is required, the semiconductor material layer 600 can be used as a substrate. However, if the semiconductor material layer 600 is used to e.g., fabricating LED of FIGS. 3A, 3B, the semiconductor material layer 600 can be part of the clad layer.

The recesses 602 can be formed through, e.g., photolithographic and etching process of the semiconductor technique. In order to achieve the desired polarization effect, the length of the recess in the direction vertical to the semiconductor material layer 600 is, e.g., about a wavelength. However, the length is not limited, and lengths may vary depending on the design, thus achieving different polarization effects. Therefore, the length can be preferably larger than or equal to λ/4. Also, in order to have different refractive indexes, the recesses 602 can be holes or be filled with dielectric materials of different substances, for example, organic materials, metal materials, polymers, solid materials, or liquids. Then, in FIG. 10B, another semiconductor material layer 604 is formed on the semiconductor material layer 600 through, e.g., wafer bonding or fusion. The semiconductor material layer 600 and the semiconductor material layer 604 are preferably formed of the same material. Also, the semiconductor material layer 600 and the semiconductor material layer 604 also can be formed of a dielectric substance (or multiple layered film). The selection of materials depends on the actual requirements. The recesses 602 are used for forming the above-mentioned medium nodes 214 (or photonic crystal structures), and therefore, their positions are preset. Also, the shape of the recesses 602 may be varied, like, for example, a cylinder, sphere, or upstanding ellipse, but is not limit to these shapes. For example, the medium nodes 214 further can be holes, holes filled with dielectric materials, holes filled with organic materials, holes filled with metal materials, holes filled with solid materials, holes filled with multiple layers of solid materials, or holes filled with liquids, or holes combined of any two or more of the above-mentioned materials. Also, FIGS. 10C and 10D show the polarized structure made up of cylinder medium nodes. Cylinder medium nodes 606 can be formed on the semiconductor material layer 600. After another semiconductor material layer 608 deposited on the cylinder medium nodes 606, the cylinder medium nodes 214 form the array structure of the EM polarizing structure.

The EM polarizing structure depicted in the present invention includes a layer of two-dimensional asymmetric medium node array, wherein the two polarizing degenerate modes, e.g. TE and TM modes, can be separated or converted by using a set frequency, with the design that the medium nodes 214 are substantially asymmetrical with respect to the operation axis.

With the above polarizing structure, the EM polarizing device depicted in the present invention can generate the polarized EM wave efficiently, and especially, it can be used on the LED or VCSEL to generate the polarized light directly. And the EM polarizing structure can be further integrated into the LED, or the laser diode.

It will be apparent to those skilled in the art that various modifications and variations can be made on the structure of the present invention without departing from the scope or spirit of the invention. In view of the foregoing, it is intended that the present invention cover modifications and variations of this invention provided they fall within the scope of the following claims and their equivalents.

What is claimed is:

1. An electromagnetic (EM) polarizing structure, comprising:
at least one layer of solid materials, having medium nodes distributed at least as a two-dimensional unit lattice cell array on a plane, wherein the unit lattice cell has an operation axis, which passes the diagonal, and the medium nodes are distributed asymmetrically with respect to the operation axis.

2. The EM polarizing structure of claim 1, the medium nodes are substantially vertical to a horizontal cross-sectional direction of the polarizing layer, and have a depth being larger than or equal to a quarter of one EM wavelength.

3. The EM polarizing structure of claim 1, wherein the polarized EM wave is selectively obtained by either one or several of similar TE (or TM) eigen modes on point Γ of a photonic band structure of the two-dimensional asymmetric unit lattice cell array as a result of different frequency and mode responses of the passing EM wave interaction with the array.

4. The EM polarizing structure of claim 1, wherein the polarized EM wave is produced by either one or several of similar TE (or TM) modes, and the corresponding electric field direction is uniform and in a single direction with respect to the plane.

5. The EM polarizing structure of claim 1, wherein the unit lattice cell of the two-dimensional unit lattice cell array comprises a non-symmetric unit cell, which is asymmetric with respect to the operation axis.

6. The EM polarizing structure of claim 1, wherein the medium nodes can be holes, holes filled with dielectric materials, holes filled with organic materials, holes filled with metal, holes filled with solid materials, holes filled with polymers, holes filled with stacked layers of solid materials, holes filled with liquids, or holes filled with any two or more of the above-mentioned materials.

7. The EM polarizing structure of claim 1, wherein the medium nodes can be posts, posts made up of solid materials, posts made up of multiple layers of solid materials, post made up of polymers, post made up of metal posts made up of organic materials, or posts made up of any two or more of the above-mentioned materials.

8. The EM polarizing structure of claim 5, wherein a center of each unit lattice cell further comprises a central medium node which is the same as the other medium nodes.

9. The EM polarizing structure of claim 1, wherein a shape of the medium nodes is symmetric or asymmetric with respect to the operation axis.

10. The EM polarizing structure of claim 1, wherein a refractive index of the medium node is different from that of a surrounding cladding background.

11. A polarized EM emitting device for generating a polarized EM wave, comprising:
at least an EM polarizing structure, wherein EM polarizing structure having medium nodes distributed in at least one two-dimensional unit lattice cell array, wherein the unit lattice cell of the array has an operation axis, which passes the diagonal, and the medium nodes are distributed asymmetrically with respect to the operation axis;
a radiation structure associated with the EM polarizing structure, capable of emitting an EM wave, when operated, disposed between a layer of first conductivity type and a layer of second conductivity type; and
electrodes associated with the layer of first conductivity type and the layer of second conductivity type, wherein the device thus emits polarized light when an appropriated operation voltage is applied on the electrodes.

12. The polarized EM emitting device of claim 11, the medium nodes are substantially vertical to a cross-sectional surface of the polarizing layer, and have a depth being larger than or equal to a quarter of the wavelength of the EM wave.

13. The polarized EM emitting device of claim 11, wherein the polarized EM wave is generated through the interaction of the passing EM wave and the two-dimensional array, and the relationship there-between is predetermined by either one or several of similar TE or TM eigen modes on point Γ of the photonic band structure as a result of different frequency and mode response of the EM wave while propagating through the two-dimensional asymmetric unit lattice cell array.

14. The polarized EM emitting device of claim 11, wherein the polarized EM wave is either one or several of similar TM or TM eigen modes, and the corresponding electric field direction is uniform and in a single direction with respect to a plane.

15. The polarized EM emitting device of claim 11, wherein the unit lattice cell of the two-dimensional array comprises a non-symmetric unit cell, which is not symmetric with respect to the operation axis.

16. The polarized EM emitting device of claim 11, wherein the center of each the unit lattice cell further comprises a central medium node which is the same as the other the medium node.

17. The polarized EM emitting device of claim 11, wherein the medium node comprises an
asymmetric complex medium node distribution with respect to the operation axis on a plane.

18. The polarized EM emitting device of claim 11, wherein a shape of each medium node is symmetric or asymmetric with respect to the operation axis.

19. The polarized EM emitting device of claim 11, wherein the refractive index of the medium node is different from that of the surrounding cladding background.

20. A method of fabricating an electromagnetic (EM) polarizing structure, wherein the method comprising:
forming at least one layer of solid materials, having the medium nodes distributed at least as a two-dimensional asymmetric unit lattice cell array on a plane, wherein the unit lattice cell has an operation axis, which passes the diagonal, and the medium nodes are distributed asymmetrically with respect to the operation axis.

21. A method of fabricating a polarized EM emitting device, wherein the method comprising:
forming at least an EM polarizing structure, wherein the EM polarizing structure, having medium nodes distributed at least as a two-dimensional asymmetric unit lattice cell array on a plane, wherein the unit cell has an operation axis, which passes the diagonal, and the medium nodes are distributed asymmetrically with respect to the operation axis;
forming a radiation (or active layered) structure associated with the EM polarizing structure, capable of emitting an EM wave when operated, disposed between a layer of first conductivity type and a layer of second conductivity type; and
forming electrodes associated with a layer of first conductivity type and a layer of second conductivity type wherein the device thus emits polarized light when an appropriated operation voltage is applied on the electrodes.
